(19) United States
(12) Patent Application Publication
(10) Pub. No.: US 2012/0028224 A1
(43) Pub. Date: Feb. 2, 2012

(54) METHOD OF CREATING A WORK OF ART

(76) Inventors: GLORIA P. SYMONS, Ames, IA (US); PATRICIA E. FOX, Ames, IA (US); SARA JEAN VOUTHILAK, Ames, IA (US)

(21) Appl. No.: 12/845,026

(22) Filed: Jul. 28, 2010

(51) Int. Cl. G09B 11/10

(52) U.S. Cl. 434/84

(57) ABSTRACT

A method of creating a work of art where a plurality of artists, using a selected palette, exchange the work after painting for a selected period of time until completed. Once completed, the painting surfaces are combined to create a single piece.

### BACKGROUND OF THE INVENTION

This invention is directed to a method of creating a work of art or more specifically a method where artists collaborate to create a piece of art.

Typically, creating a piece of art is an individual, and sometimes isolated activity. While creativity can be enhanced in peace and solitude there are times when artists become blocked. Accordingly, a need exists in the art for a method that assists artists when blocked, fosters collaboration, and promotes team building. There also exists a need for a method that can be used in and to promote art therapy, stress management, self-help, self-discovery, cooperation, acceptance, tolerance, ice breaking, relationship building, positive energy, mediation, confronting ego, ego release and creativity.

Therefore, an objective of the present invention is to provide a method for creating a work of art that provides a structure for artists to work together.

This and other objectives will be apparent to those skilled in the art based on the following written description.

### SUMMARY OF THE INVENTION

A method of creating a work of art where a plurality of artists, using a selected palette, exchange painting surfaces after painting for a selected period of time until completed. Once completed, the painting surfaces are combined to create a single piece.

### BRIEF DESCRIPTION OF THE DRAWINGS

FIG. 1 is a flow diagram of a method of creating a work of art.

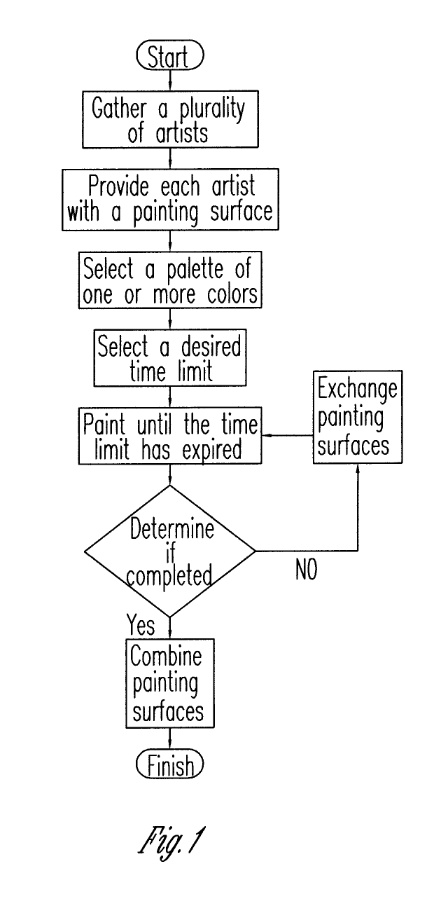

### DETAILED DESCRIPTION OF THE PREFERRED EMBODIMENTS

The method of creating a work of art begins by gathering a plurality of artists and providing the artists with a plurality of painting surfaces. Next the artists select a desired medium and palette of one or more colors and a desired time limit typically based upon the size of the painting surfaces. The artists may also select limitations on the type of brushes used. Once selected, each artist selects a painting surface and begins painting with the selected palette until the desired time limit expires.

Once the time limit expires, an artist passes their painting surface to an adjacent artist and receives a painting surface from an adjacent artist. Once painting surfaces are exchanged, the artists begin painting on the exchanged painting surfaces until the desired time limit expires and the painting surfaces are exchanged again. This process of exchanging and painting continues until the paintings are completed. Once completed, the plurality of painting surfaces are combined in any conventional manner to create a single piece of art.

Therefore, a method of creating a work of art has been disclosed that, at the very least, meets all the stated objectives.

What is claimed is:

1. A method of creating a work of art, comprising the steps of:
gathering a plurality of artists;
providing each artist with a painting surface;
selecting a palette having at least one color;
selecting a desired time limit;
painting on the painting surface using the selected palette for the desired time limit;
exchanging the painting surface between artists upon expiration of the time limit;
repeating the steps of painting and exchanging based on the time limit until completed; and
combining the painting surfaces to make a single piece.
